(19) United States
(12) Patent Application Publication
(10) Pub. No.: US 2018/0253440 A1
(43) Pub. Date: Sep. 6, 2018

(54) USER INITIATED AND AUTOMATIC CONDITIONAL DELETION

(71) Applicant: TRANSITIVE INNOVATION, LLC, NEWPORT, RI (US)

(72) Inventors: Tyler G. Levesque, West Warwick, RI (US); Michael E. Levesque, Newport, RI (US)

(21) Appl. No.: 15/449,064

(22) Filed: Mar. 3, 2017

(51) Int. Cl. G06F 17/30

(52) U.S. Cl. CPC G06F 17/30117; G06F 17/30126

(57) ABSTRACT

The present disclosure relates to methods and apparatus where a user may enter information into a computing device that may allow the computing device to delete data or files that are stored at a plurality of different electronic devices. Methods and systems consistent with the present disclosure allow a user to enter conditions that correspond to a rule for deleting data stored at one or more specific electronic devices. The information entered by the user may be entered over a graphical user interface (GUI) at a user device.

### BACKGROUND OF THE INVENTION

### Field of the Invention

The present invention is generally directed to systems and methods setting rules for controlling the storage of data. More specifically, the present invention provides a user the ability to set conditions that get executed at the right conditions parameters (time, storage type, storage amount etc.,) that relate to deleting data that may be stored at one or more electronic devices.

### Description of the Related Art

Today, methods and systems for identifying rules for deleting data stored at various pieces of electronic devices are limited. Such rules may be to scan a disk once a month at a certain time to defragment it. Other such rules may be to scan a disk for security issues and alert user. Today the amount of data that is stored on different electronic devices grows every day and users wishing to limit or manage that growth in stored data are overwhelmed with managing data that may be spread over various different devices that they may own or that they may use. Also, users that have cloud data as a backup may find they have multiple copies of the data. Data such as photos are stored in many devices, a smartphone, a smartwatch and a cloud service, where the user may quickly lose track of which photo's that would want resident on the smart watch or smartphone to minimize storage. Additionally the storage of sensitive data, meaning data that either contains personally identifiable information, regulated data, financial information, classified data, or any data that would cause harm to an individual or an organization if it were to be compromised, has now become a liability. Data Liability Insurance is now available to guard against the potential financial loss associated with storing sensitive data.

Typically, a user may access different electronic devices individually, select individual files stored on each of those electronic devices, and manually command the deletion of unwanted data when they wish to control an amount of data stored on their devices.

Because of the immense growth in user data, and the fact that users have limited time to manage their data, what are needed are systems and methods that allow users to set rules that automatically delete data from different devices that they may own or use.

Today, a user is inundated with learning many user interfaces for different devices. This is also true for viewing and managing storage. In some devices, options are limited on how to view and manage storage on the devices. What are also needed are apparatus and methods that allow a user to use a single interface when controlling or commanding the deletion of data that are stored on a plurality of different electronic devices.

### SUMMARY OF THE PRESENTLY CLAIMED INVENTION

The presently claimed invention relates to apparatus, methods, and non-transitory computer readable storage mediums that allow a user to classify files or data of a user or of an entity. A method of the presently claimed invention may include displaying one or more conditions in a graphical user interface (GUI) on a display that identifies a rule for deleting data. The presently claimed method may also include receiving inputs that correspond to the rule for deleting data, where those inputs may identify an electronic device, identify a threshold type, set a range that may be associated with the rule, and that may identify the rule for deleting the data. After the inputs that correspond to the rule for deleting data are input over the GUI, a user may accept the rule for deleting the data, and that data may be deleted from the electronic device based on the inputs that correspond to the rule for deleting the data when conditions that are associated with those inputs are satisfied.

When the presently claimed invention is implemented as a non-transitory data storage medium, a processor executing instructions out of a memory may perform steps of the method. In such an instance, the method of the presently claimed invention may include displaying one or more conditions in a graphical user interface (GUI) on a display that identifies a rule for deleting data. The presently claimed method may also include receiving inputs that correspond to the rule for deleting data, where those inputs may identify an electronic device, identify a threshold type, set a range that may be associated with the rule, and that may identify the rule for deleting the data. After the inputs that correspond to the rule for deleting data are input over the GUI, a user may accept the rule for deleting the data, and that data may be deleted from the electronic device based on the inputs that correspond to the rule for deleting the data when conditions that are associated with those inputs are satisfied.

An apparatus consistent with the presently claimed invention may include a memory, a processor, and a display that controls the deletion of data stored at various different electronic devices according to rules that are configured over a GUI displayed on the display. In such an instance the (GUI) displayed on the display may identify a rule for deleting data may receive inputs that correspond to the rule for deleting the data, where those inputs may identify an electronic device, identify a threshold type, set a range that may be associated with the rule, and that may identify the rule for deleting the data. After the inputs that correspond to the rule for deleting data are input over the GUI, a user may accept the rule for deleting the data, and that data may be deleted from the electronic device based on the inputs that correspond to the rule for deleting the data when conditions that are associated with those inputs are satisfied.

### BRIEF DESCRIPTION OF THE DRAWINGS

FIG. 1 illustrates an exemplary user device or electronic terminal that allows a user to identify conditional deletion rules for deleting data or files that may be stored at an electronic device.

FIG. 2 illustrates an exemplary user interface consistent with the present disclosure.

FIG. 3 illustrates an exemplary graphical user interface (GUI) that a user may use when setting entries that may be used to identify files targeted for deletion.

FIG. 4 illustrates an exemplary conditional deletion GUI consistent with the present disclosure.

FIG. 5 illustrates another exemplary conditional deletion GUI consistent with the present disclosure.

FIG. 6 illustrates an exemplary analysis report GUI consistent with the present disclosure.

FIG. 7 illustrates an exemplary flow chart that of a method that may be implemented by apparatus consistent with the present disclosure.

FIG. 8 illustrates an exemplary flow chart of a method that may be implemented by an analysis software module consistent with the present disclosure.

FIG. 9 is a block diagram of an exemplary system for implementing a computing device.

### DETAILED DESCRIPTION

The present disclosure relates to methods and apparatus where a user may enter information into a computing device that may allow the computing device to delete data or files that are stored on the user device or at a plurality of different electronic devices. Methods and systems consistent with the present disclosure allow a user to enter conditions that correspond to a rule for deleting data stored at one or more specific electronic devices. The information entered by the user may be entered over a graphical user interface (GUI) at a user device.

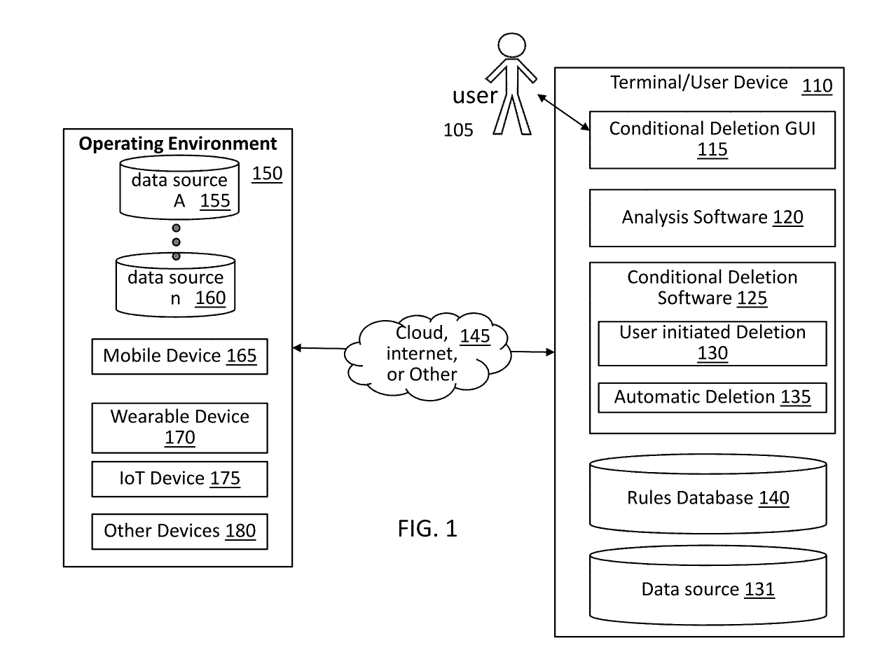

FIG. 1 illustrates an exemplary user device or electronic terminal that allows a user to identify conditional deletion rules for deleting data or files that may be stored at an electronic device. FIG. 1 includes a user 105 interacting with terminal/user device 110 over a user interface when organizing data from various devices of operating environment 150. The terminal/user device 110 may be a desktop or laptop with the ability to have a large screen and keyboard to take advantage of the viewing and interacting with the apparatus and method Graphical User interface. However, the terminal/user device 110 may also be any interactive device. User/terminal device 110 of FIG. 1 may be a desktop or laptop which allows a user to connect to the cloud, internet, or other connection schema 140 to then attach to other devices. It should be obvious to those skilled in the art that a user can attach to any device that may have (smartphone mobile device, wearable device, cloud storage device, IOT device, or other device(s)) and that each have their own Applications and API to exchange commands to view data and to delete data. User or terminal device 110 of FIG. 1 base software 130 manages the other software modules. It should be noted that data source 131 is the User or terminal device 110 of FIG. 1 data storage itself, which is locally accessed. User or terminal device 110 of FIG. 1 includes conditional deletion graphical user interface (GUI) 115, analysis software 120, conditional deletion software 125 and a rules database 140 and data source 199. Data Source 131 is Terminal/User device 110 storage which may be disk drives, solid state drives, flash drives, etc. Terminal/User device 110 may communicate with one or more external electronic devices of operating environment 150 via a computer network interface. As such, user device 110 may communicate over an intranet, an Internet connection, or communicate with storage resources located in the Cloud 145 when data or files are classified. Operating Environment 150 illustrates a plurality of data sources, such as: data source A 155 through data source N 160, mobile device 165, wearable device 170, Internet of Things (IoT) device 175, or other devices 180. Apparatus and methods consistent with the present disclosure may allow a user to enter information over a user interface to identify conditions for the automatic deletion of data according to settings or inputs received via conditional deletion GUI 115. It should be obvious of those skilled in the art that terminal/user interface 110 can be used to access and control storage of all devices the user may own, via the cloud, internet, intranet, or other connection schema 140.

Conditional deletion software 125 sets up the rules and executes conditional deletion and automatic deletion of storage devices based upon filters applied to conditional deletion GUI 115.

Note that devices in operating environment 150 may be a combination of devices that are owned by a particular user or that may be owned by a company that stores data for the user. For example, data sources A 155 & B 160 may be data storage devices in a data center located in the Cloud that is operated by a company. Mobile device 165 and wearable device 170 are examples of devices that may be owned by a user.

Operating environment is defined as the collection of data sources accessed by the Terminal/User interface 110 in that, by the terminal/user interface 110 can link to external devices, and any of those externally devices are considered the operating environment 150. Analysis software 120 or conditional deletion software 125 does not show the specifics of how these external devices and data sources are linked to create the operating environment 150, but is should be obvious to those skilled in the art that these are device settings to connect via URL connections, cellular, or other connection schema.

Apparatus and methods consistent with the present disclosure allow a user to enter settings set over a single user interface at a single device that affect policies or rules regarding when data may be deleted from one or more devices.

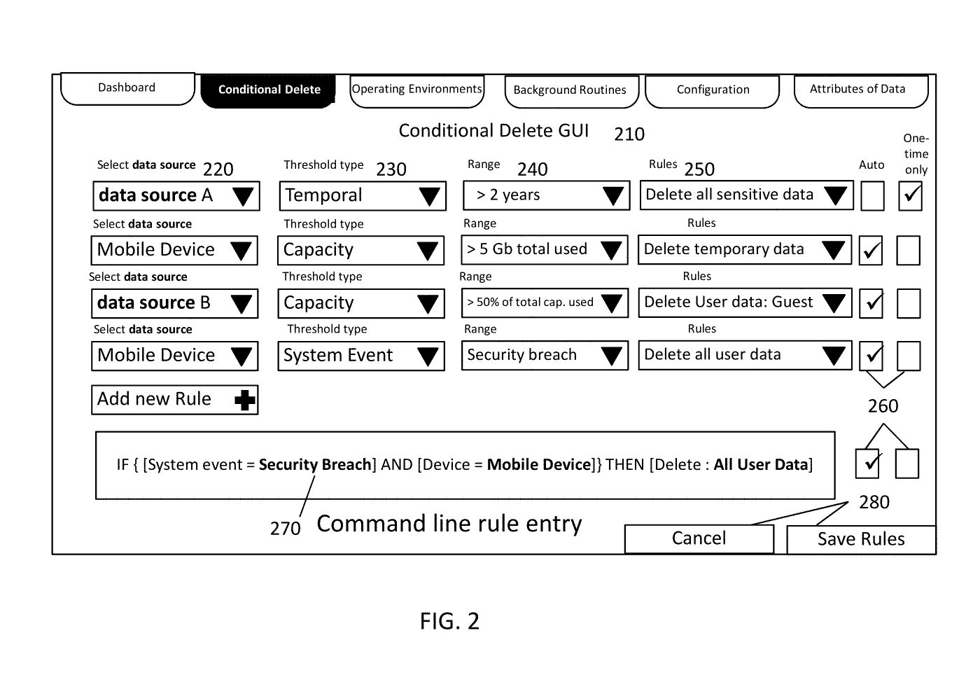

FIG. 2 illustrates an exemplary user interface consistent with the present disclosure. A conditional deletion GUI 210 of FIG. 2 includes a set of selection boxes 220 where a data source may be selected, a group of selection boxes that identify a threshold 230, a set of range selection boxes 240, and a group of rule selection boxes 250. FIG. 2 includes check boxes 260 that allow a user to identify whether certain types of data files should be automatically deleted or deleted only once. FIG. 2 also includes an entry box where a command line rule may be specified via a written command. FIG. 2 also includes selection boxes 280 that may be used to cancel or save rules or selections that have been entered in classification GUI 210.

Note that the data source 220, the threshold type 230, the range 240, and the rules 250 selection boxes of FIG. 2 are arranged like columns in a “table.” Note also, that a first row of this “table” of FIG. 2 identifies data source A, that threshold types of “temporal” (i.e. time based), are associated with a range of greater (>) than 2 years, and with a rule to delete all sensitive data. Note also that the check boxes 260 that are associated with this first row indicates that data related to this rule will be deleted one time only. As such, the rule associated with this first row of FIG. 2 will delete all data that is classified as “sensitive” data that are older than 2 years old once only. Note that different rows of the GUI 210 of FIG. 2 identify other electronic devices, such as a mobile device and data source B.

Other threshold types included in the GUI 210 are capacity and system events. Other ranges illustrated in FIG. 2 are range and usage levels, such as today it could be >5 GB memory usage, >50% of total capacity used, and a security breach. Because of this data may be deleted according to a rule after a certain percentage of a total available memory is consumed or may be deleted according to a rule when more than a threshold number of bytes are consumed or according to a rule related to a security breach.

Note also that other rules included in FIG. 2 included in FIG. 2 are delete all “temporary” data, delete “guest” data, and delete “user” data.

Conditions and rules set in GUI 210 may identify under what conditions data of certain data types may be deleted automatically or once in as a single event. Examples of data types include, yet are not limited to “sensitive,” “temporary,” “guest,” and “user.” Depending on the various selections in the GUI 210 of FIG. 2, data or files that are associated with particular types of data may be deleted.

FIG. 2 includes a command line rule entry selection box 270 where a user may enter an if-then command that includes one or more logical operators. The if-then command of the command line classification entry box 270 includes the if-then command of: IF (system event=security breach) AND (device=mobile device) THEN (delete all user data). This if-then command will delete all user data stored at a mobile device after a security breach has been identified. Not shown, it should be obvious to those skilled in the art, that the command line can be parsed according to a parsing program. Each parsed parameter (e.g. “security breach”) is passed logically to its resultant execution program (that is , is “there a security breach”) and the resultant execution result (e.g. “yes there is a security breach” and a logical out put that then executes (if the parsed operator is an “AND” then the next parsed parameter (e.g. “mobile device”) and the execution see a “Mobile device” and returns a “yes there is a mobile device”) then the AND is satisfied and the command line executes the command “Delete all user data on the Mobile device”. In this way any command line can be written to initiate parsed parameters and logical operators and execution of the command line rule. It should be obvious to those skilled in the art that any rule of any complexity can be written as is known in the art related to storage management.

The conditional delete GUI 210 allows the user to set thresholds types 230 on data sources 220 for ranges 240 for any rules available 250. However, Conditional GUI allows for a separate unique command line operation that allows for any rule that may not simply be a set of filters such as those set by user to set thresholds types 230 on data sources 220 for ranges 240 for any rules available 250. For instance, a command line can include parsed data that is not in the set of filters, such as, IF {[date>2-02-2018] THEN [do not delete any data without user ok]}. This rule is not selectable by filter selections but utilizes the system complexities as it is well known to be able to check the date and it is well known to stop a rules from execution and it is well known to notify a user. In this way, a command line is used for more complex storage management.

Note that FIG. 2 also includes a selection box of “add new rule.” When the “add new rule” selection button is selected, a new row of entries may be opened in the table of classification GUI 210. Once a new row is opened in the conditional deletion GUI 210, a user of may make a new set of entries that may be used to cross reference to select a data source, a threshold type, a range value, a condition, and a conditional deletion rule. The “add new rule” allows a user further flexibility to manage storage, to add more rules than the minimum set of rules that the system initially shows.

FIG. 2 also includes selection boxes of cancel and save rules. When the cancel selection button is selected, changes to entries made in the classification GUI 210 may be cancelled. When the save rules button is selected rules entered in the conditional deletion GUI 210 will be persistently saved.

Notice also that FIG. 2 includes various selection tabs of dashboard, conditional delete, operating environments, background routines, configuration, and data attributes. Note also of these selection tabs that “conditional delete” is selected as indicated by the conditional tab being black.

FIG. 2 utilized “fixed conditions”, that is conditions that are selectable from drop down menus preconfigured in conditional GUI 115. FIG. 2 also utilizes “non-fixed conditions”, that is, flexible command line rule entry of conditional GUI 115.

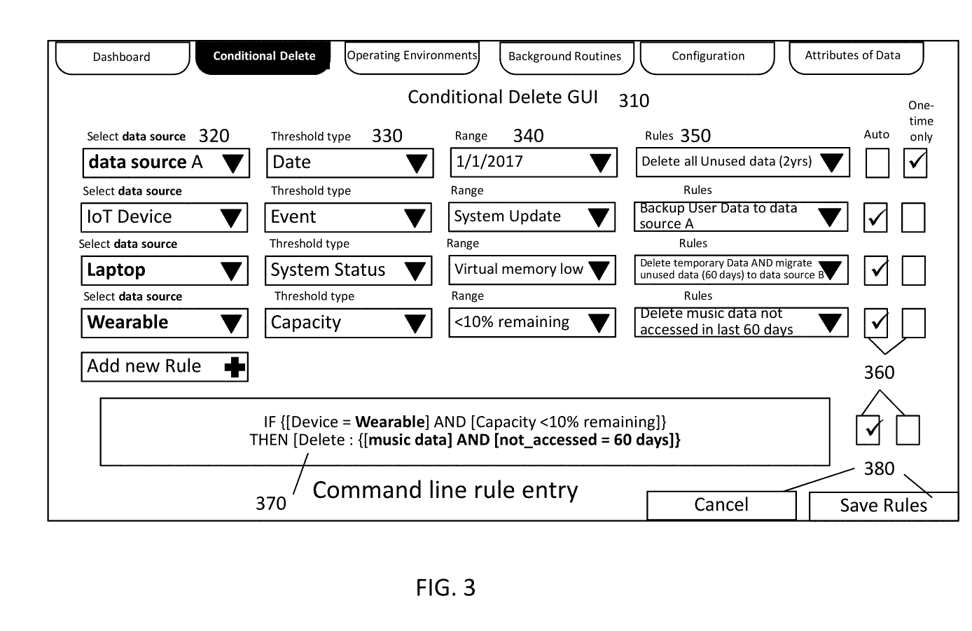

FIG. 3 illustrates an exemplary GUI that a user may use when setting entries that may be used to identify data or files targeted for deletion. The classification GUI of FIG. 3 includes a “select data source” selection box 320, a “threshold type” selection box 330, a “range” selection/data entry box 340, and a “rules” selection/data entry box 350. FIG. 3 also includes a command line rule entry box 370, a “add new rule” selection box, and check boxes 360. Note that the check boxes 360 of FIG. 3 include an “automatic” check box and a “one time only” check box that may be used when conditional deletion rules are set and saved in conditional deletion GUI 310. FIG. 3 also includes selection boxes of cancel and save classification rules.

The classification GUI of FIG. 3 may be used in a similar manner as the classification GUI 210 of FIG. 2 that was previously discussed. Note that data sources include in FIG. 3 are data source A, Internet of things (IoT) device, laptop, and wearable device. Threshold types of FIG. 3 include “date,” “event,” “system status,” and “capacity.” Ranges entries included in FIG. 3 are a date of 1/1/2017, an entry of “system event,” “virtual memory low,” and “less than 10% remaining.” Rules included in FIG. 3 are delete all unused data (2 yrs), backup user data to data source A, delete temporary data and migrate unused data (60 days) to data source B, and delete music data not accessed in 60 days.

As such, data may be deleted at one or more electronic devices according to a system status, after an event has been identified (such as a system security breach, a threat to system security, or a system security policy change), or according to a capacity threshold trigger. Rules relating to the deletion of data after a span of time may identify that data that has not been accessed or updated for a span of time (such as 2 years or 60 days) may identify that certain specific data may be deleted based threshold settings or range settings entered into the conditional deletion GUI 310 of FIG. 3.

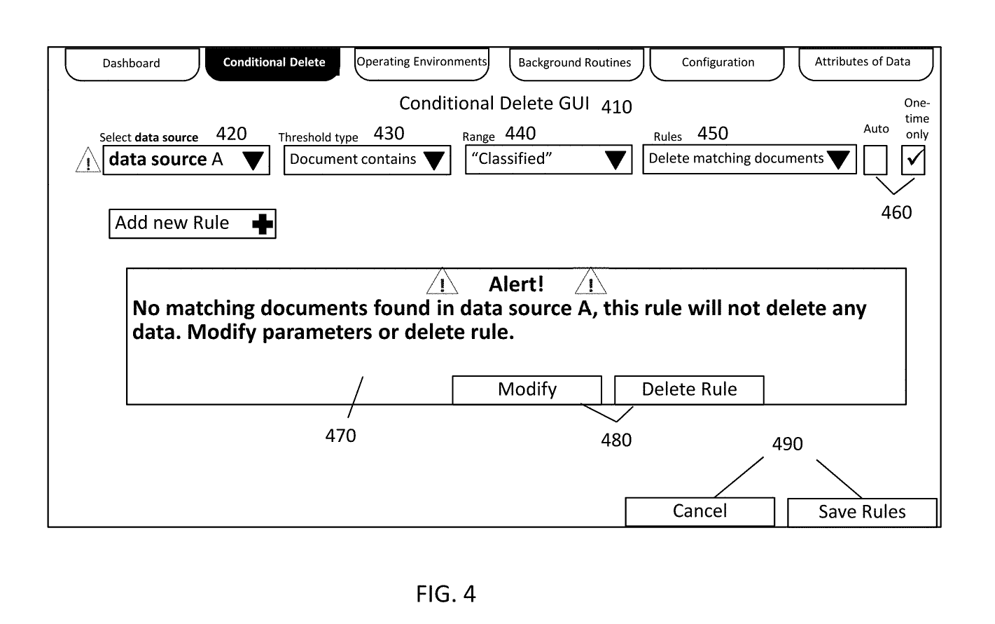

FIG. 4 illustrates an exemplary conditional deletion GUI consistent with the present disclosure. The conditional deletion GUI 410 of FIG. 4 includes a select data source selection box 420, a threshold type selection box 430, a range selection box 440, and a rule selection box 450. Note that selections in the GUI 410 of FIG. 4 identify “data source A,” a threshold type of “document contains,” a range of “classified,” and a rule of “delete matching documents.” Note also that check boxes 460 allow a user to select whether a rule in rule selection box 450 will be followed one time only or automatically based on whether the “auto” check box or the “one time only” check boxes are selected.

Because of the entries illustrated in the conditional deletion GUI 410 of FIG. 4, documents stored at “data source A” with a range value of “classified” should be deleted one time only. Note that text box 470 of FIG. 4 includes an “alert message” that indicates that no documents were found at “data source A” that matched the rule (delete matching documents) and because of that, this rule will not delete any data. In this way a user is told in advance that the rule could not be applied. This alert feature is more than a rule system checker, as it checks the data sources and the filters to see if the rule can actually be executed. Text box 470 also identifies that parameters associated with the rule of the conditional deletion GUI 410 can be modified or deleted. Note that selection boxes 480 of “modify” and “delete rule” that may be used to modify entries in the conditional deletion GUI 410 or that may be used to delete this rule. As such, when a user selects the “modify” selection box, the user may change entries in selection boxes 420, 430, 440, or 450 or the user may delete this entire conditional deletion rule by selecting “delete rule.” It should be obvious to those skilled in the art that an alert message may be prompted at any time a rule cannot be applied, for instance, if a rule deletes all mobile device data after a security breach, then any other rules that manage the data of a mobile device will likely cause and alert as it not possible to be executed. It should be also obvious to those skilled in the art that other feedback to managing storage (that affects the execution of rules) may be shown in 470 text box, such as, but not limited to, (1) a storage device is not found, (2) storage device may be behaving erratically, (3) storage device has been changed or upgrade, (4) storage device is off line, etc.

Note that the conditional delete GUI 410 of FIG. 4 also includes selection boxes 490 that allow a user to cancel changes recently made in selection boxes 420, 430, 440, and 450 or to persistently save an entire rule that is associated with current entries in selection boxes 420, 430, 440, and 450 by selecting either the “cancel” selection box or the “save rules” selection box of selection boxes 490. Note also that FIG. 4 includes an “add new rule” selection box that may be selected when a user wishes to add a new rule to conditional deletion GUI 410.

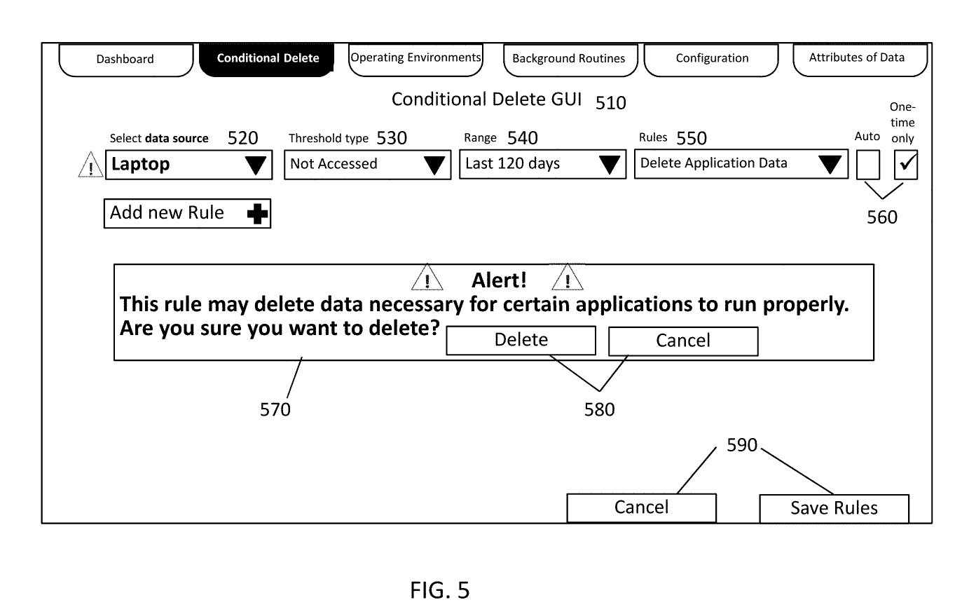

FIG. 5 illustrates another exemplary conditional deletion GUI consistent with the present disclosure. The conditional deletion GUI 510 of FIG. 5 includes a select data source selection box 520, a threshold type selection box 530, a range selection box 540, and a rule selection box 550. Note that selections in these selection boxes identify a data source of a “laptop,” a threshold type of “not accessed,” a range of “last 120 days,” and a rule of “delete application data.” Note also that check boxes 560 allow a user to select whether a rule in rule selection box 550 will be followed one time only or automatically based on whether the “auto” check box or the “one time only” check boxes are selected.

Note that FIG. 5 includes text box 570 that contains an alert message that states “this rule may delete data necessary for certain applications to run properly. Are you sure you want to delete?” Note also that text box 570 also includes selection boxes 580 that allow the user to select “delete” or “cancel.”

Based on these settings in the conditional deletion GUI 510 of FIG. 5, application data stored at the “laptop” of the user that have not been accessed in the last 120 days will be deleted “one time only” if the user selects the “delete” selection box of selection box 580. Alternatively, this deletion process may be cancelled when the user selects the “cancel” selection box of selection boxes 580.

Note that the conditional delete GUI 510 of FIG. 5 also includes selection boxes 590 that allow a user to cancel changes recently made in selection boxes 520, 530, 540, and 550 or to persistently save an entire rule that is associated with current entries in selection boxes 520, 530, 540, and 550 by selecting either the “cancel” selection box or the “save rules” selection box of selection boxes 590. Note also that FIG. 5 includes an “add new rule” selection box that may be selected when a user wishes to add a new rule to conditional deletion GUI 510.

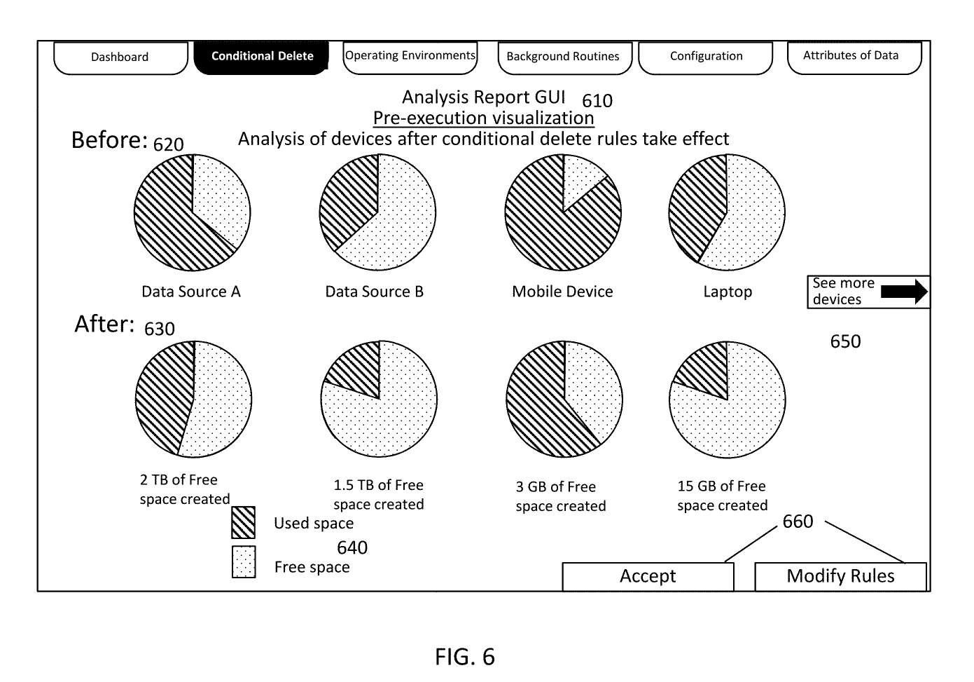

FIG. 6 illustrates an exemplary analysis report GUI consistent with the present disclosure. The analysis report GUI 610 of FIG. 6 includes a set of before pie charts 620 and a set of after pie charts 630. The pie charts 620/630 of FIG. 6 identify how much data storage space (i.e. capacity) at particular electronic devices are or will be “used” or that are or will be “free” before and after a deletion rule has been accepted or implemented. Template 640 of FIG. 6 identifies a portion of “used space” (i.e. used data storage space) and a portion of “free space” (i.e. currently un-used, “free” data storage space) at the various electronic devices of “data source A,” “data source B,” a “mobile device,” and a “laptop.”

Note that the before pie charts 620 and the after pie charts 630 include different amounts of “free space” and different amounts of “used space” for each of the various electronic devices that are identified in FIG. 6. The before 620 and after 620 pie charts are visualizations that identify how one or more conditional deletion rules will affect an amount of “free space” and an amount of “used space” will change if and when the one or more conditional deletion rules are performed. The before 620 and after 630 pie charts of FIG. 6 illustrate amounts of “free space” and amounts of “used space” that may be measured in bytes, megabytes, gigabytes (GB), or in terabytes (TB), or any other user defined unit of measure. Note also that FIG. 6 indicates that conditional deletion rules that if enacted will free up (i.e. create) 2 TB of space at data source A, will free up 1.5 TB of space at data source B, will free up 3 GB of space at the mobile device, and will free up 15 GB of space at the laptop of FIG. 6.

FIG. 6 also includes a “see more devices” data selection box. If a user selects this “see more devices” selection box, the visualization of FIG. 6 may be changed such that pie charts that may be associated with other devices may be viewed by the user.

FIG. 6 also includes selection boxes 660 of “accept” and “modify rules.” In an instance when the “accept” data selection box of FIG. 6 is selected, any rules that were previously configured will be enacted at a point in time when conditional limitations relating to those rules are met. In an instance where the “modify rules” selection box of FIG. 6 is selected, a conditional rule GUI like the conditional rule GUIS of FIG. 2, 3, 4, or 5 may be displayed on a display of a user device where a user may change one or more conditional limitations of a particular rule as they desire.

It should be obvious to those skilled in the art that before and after time windows based upon potential rule execution is just one example of analysis report GUI 610. Analysis report GUI 610 can also include, but is not limited to (1) visualizations of data costs, (2) visualizations of data environmental impact, (3) visualization of comparisons to the mean or median of a population of users, (4) visualization of the reduction of “Data Risk Liability” (based on the percentage reduction in storage of sensitive, regulated, or classified data), (5) visualization of speed impact of execution of rules (that is less storage speeds up access) , (6) visualization of fragmentation of storage device etc.

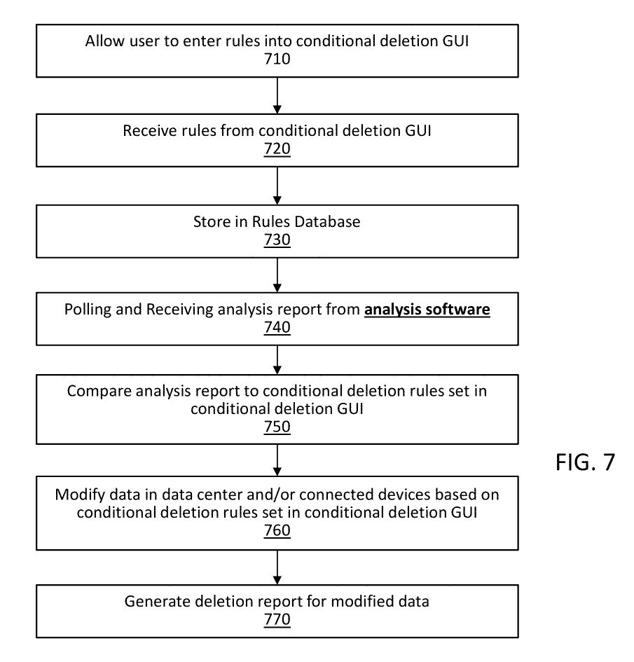

FIG. 7 illustrates an exemplary flow chart that of a method that may be implemented by apparatus consistent with the present disclosure of conditional deletion software 125 of FIG. 1. Step 710 of FIG. 7 may allow a user to enter rules into a conditional deletion GUI. Such a conditional deletion GUI may appear like the conditional deletion GUI'S illustrated in FIGS. 2-5. In step 720 of FIG. 7 a processor at a user device may receive rules from the conditional GUI. Next, the processor may store the rules in a rules database in step 730.

Next step 740 of the method of FIG. 7 may poll an analysis software module for an analysis report that may be associated with the conditional deletion rules stored in the rules database. After step 740, program flow moves to step 750 where information in the analysis report may be compared to conditional deletion rules set in conditional GUI 115 of FIG. 1.

The method of FIG. 7 may then move to step 760 that may modify data stored in a data center and/or at one or more devices owned by a user based on the intelligent data retention and conditional deletion rules. Finally, step 770 of FIG. 7 may generate a deletion report relating to the data modified in step 760. The method of FIG. 7 may, thus receive various conditions for deleting data stored at one or more devices when those limitations are fulfilled.

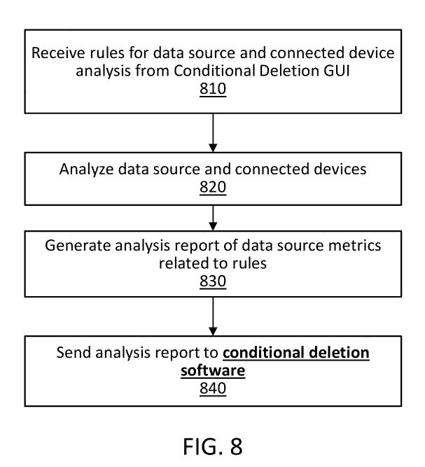

FIG. 8 illustrates an exemplary flow chart of a method of analysis software 120 of FIG. 1 that may be implemented by an analysis software module consistent with the present disclosure. Step 810 of FIG. 8 may receive rules that control when data may be deleted from a data source or from one or more other connected devices. A processor executing the analysis software module may perform an analysis relating to the data controlled by the conditions set in a conditional deletion GUI in step 810 of FIG. 8.

In step 820 of FIG. 8, data stored at the data source and/or at the other connected devices may be analyzed, after which an analysis report may be generated based on rules that were set in a conditional deletion GUI in step 830. Such a report may include metrics that identify data that will be or that have been deleted from particular devices according to the conditional deletion rules.

Finally, in step 840 of FIG. 8 the analysis report generated in step 830 may be sent to a conditional deletion software module. The conditional deletion software modules may be consistent with the steps included in the flow chart of FIG. 7.

Embodiments of the present disclosure may include different levels of deletion that may be coupled to different security levels or to different levels of secure erase. Such levels of deletion may simply deallocate blocks of memory that are associated with data when those data are deleted or may overwrite data by writing data patterns to memory blocks associated with the data when the data are deleted.

Commonly when data are deleted in a computing device, memory blocks that were used to store the data are simply deallocated by changing entries in a data system. When this occurs, the memory blocks that were used to store the data, still store that data until those memory blocks are overwritten when other data are stored at that computing device. Because of this, data deleted by simply deallocating memory blocks may be recovered by reading those memory blocks, for example, by using forensic utilities that bypass the data system of the computing device. In certain instances, conventional computing devices delete data by moving a data identifier to a “recycle bin” where they may be “recovered” with by a user making a selection. As such, conventional deletion mechanisms are inherently insecure.

Another reason for including different levels of deletion in the design of a computing device relate to the fact that sometimes overwritten data may be recovered using advanced computer forensic techniques. In order to provide maximum levels of security, memory blocks used to store data may be overwritten multiple times with one or more different data patterns during a secure erase operation. Such data patterns may include alternating ones and zeros or other patterns, such as following the write of alternating one and zeros with alternating zeros and ones.

In certain instances a level or type of deletion may selected by a user of a computing device. For example, this may be accomplished by a user selecting one or more entries in a GUI that is associated with a user's electronic device. In such instances a user may be able to select a number of overwrites used when a secure erase operation is performed.

Alternatively or additionally, data may be automatically securely erased (i.e. overwritten) to an appropriate level automatically. Such erasures may be based on a data type, be related to a type of computing device, correspond to a location where the deleted data was originally sourced from, be related to locations where the computing device currently resides, or be related to another association that corresponds to a security level. As such, levels of deletion may relate to security levels where processes related to deleting data may vary based on one or more security associations and/or location information. Exemplary security levels may correspond to one or more levels identified by the National Security Agency.

Data may be deleted from a computing device after a security breach has been identified. In such instances, a software program executing at a computing device may be used to detect security breaches. Embodiments of the present disclosure may be either loosely or tightly integrated with various Security Software capabilities that detect/identify security breaches, for the purpose of coupling the discrete capabilities and enabling the integrated capability to perform a conditional deletion after a security breach has been identified. After a security breach is identified, data may be deleted from the computing device based on the identified security breach according to one or more settings. The conditional deletion may be performed after a user has responded to a System Prompt identifying that a security breach has occurred, or it may be automated based on one or more established rules. In other instances data may be deleted automatically based on a rule set by a supervising authority. Conditions and rules used to identify data identified or a message may be displayed in a GUI at a user device that has been breached by a security threat.

Conditional retention and deletion rules may also correspond to requirements identified by government agencies, such as, but not limited to, the Federal Drug Administration (FDA), the Environmental Protection Agency (EPA), the Veterans Administration (VA), the Center for Disease Control (CDC), the Department of Defense (DoD), Department of Homeland Security (DHS), or the Intelligence Community (IC).

Embodiments of the present disclosure may execute periodically according to a schedule rather than running continuously. For example, settings set in a GUI may conditionally delete data once every six months.

In instances when data retention thresholds are enforced at a user device, they may be enforced according to a set of static rules or according to a set of dynamic conditions. Examples of static conditional deletion rules include deleting some customer data when customer data exceed a threshold of 500 MB or deleting music data when music data exceed a threshold size of 4 GB. An example of dynamic data retention thresholds may cause certain data to be deleted when they reach or cross a threshold size. As such, dynamic rules could cause data of certain types to be deleted when greater than 60% of a total amount of memory is used.

Conditional retention or deletion rules may be based on a privilege or security level. For example, the setting of conditional retention and deletion rules may require that a user be a supervisor or an administrator to change conditional deletion settings where general employees are prohibited from making such changes.

Conditional retention and deletion rules may also be used to identify properties of certain data that may be displayed in a GUI consistent with the present disclosure. In certain instances, such properties may identify or be related to an owner of data, correspond to a user of certain data types, or may include information that identifies where certain data originated. Information that identifies where certain data originated may include specific information about the device (e.g. mobile device, sensor, etc.) that originated the data, such as the type of device, manufacturer of device, model number of device, geographical location of device, or other identifying information specific to the device (e.g. IMEI of a mobile device).

Settings consistent with the present disclosure may allow a user to identify data that should not be deleted based on a conditional rule. These settings may allow a user to identify specific memories, zones of memories (i.e. memory blocks), or directories that should or should not be deleted when a conditional rule is enforced.

Data that are to be kept or deleted may be associated with one or more attributes that may be used to identify data. Such attributes may be included in metadata of particular data. These attributes may be used to identify data that are associated with a project. Attributes that are used to identify data that are associated with project that may be used by a group of individuals when that group of individuals works on the project.

GUIs consistent with the present disclosure may be used by a user to identify a range. A range may be defined by the user selecting two points in a set or list of data or files or data attributes (e.g. date of creation, size of data, source of data, etc.) and specifying a conditional rule. The conditional rule may allow the user, for example, to specify that all data or files between the two selected points will be deleted when the conditional rule is executed. Alternatively, the conditional rule may allow the user to specify that all data or files between the two selected points will be retained and that the data or files that are outside the bounds of the two specified points will be deleted. In some embodiments, multiple sets of points can be specified simultaneously, which will establish an N-dimensional space where the data within the bounds of said N-dimensional space will either be deleted or retained, based upon the definition of the rule(s).

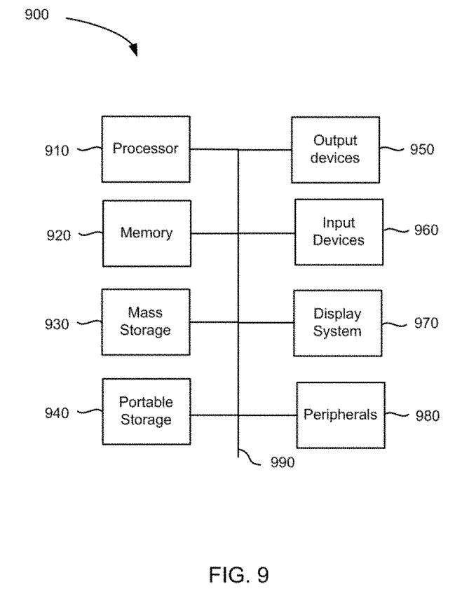

FIG. 9 is a block diagram of an exemplary system for implementing a computing device. The computing system 900 of FIG. 9 includes one or more processors 910 and memory 920. Main memory 910 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses or connection methodologies.

Mass storage device 930, which may be implemented with a magnetic disk drive, an optical disk drive, a solid-state storage device, or other method, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable nonvolatile storage medium, such as a floppy disk, compact disk, Digital video disc, memory stick (thumb drive), or other, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, cursor direction keys, a user's voice, a user's finger or stylus (for a touch screen), a game controller, a TV remote control device, gesture control, or other types of user input. Additionally, the system 900 as shown in FIG. 9 includes output devices 950. Examples of suitable output devices include speakers, printers, network interfaces, and monitors or display systems.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, iOS, Android and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for controlling the storage of data, the method comprising:
displaying a first command and a second command in a graphical user interface (GUI) on a display, wherein the first command corresponds to a first rule for deleting at least a portion of a type of data that are stored at a first electronic device of a plurality of electronic devices by identifying the first electronic device, a first range, a first threshold that corresponds to the first range, and the first rule for deleting at least the identified portion of the type of data stored at the first electronic device, and the second command corresponds to a second rule that controls the migration of data stored at a second electronic device of the plurality of electronic devices by identifying the second electronic device, a second range that is different from the first range, a second threshold that is different from the first threshold, and the second rule for controlling the migration of the identified data stored at the second electronic device;
receiving user input that executes the rules corresponding to each of the first command and the second command;
deleted deleting data from the first electronic device based on the rule corresponding to the executed first command; and
migrating data from the second electronic device based on the rule corresponding to the executed second command.

2. The method of claim 1, further comprising:
performing an analysis relating to the at least identified portion of the type of data stored at the first electronic device;
generating a visualization that identifies changes in data stored at the first electronic device; and
displaying the visualization on the display.

3. The method of claim 2, wherein the visualization identifies changes in an amount of data storage space at the first electronic device that will be available for storing other data at the first electronic device at a time after the at least identified portion of the type of data is deleted from the first electronic device as compared to before the at least identified portion of the type of data is deleted from the first electronic device.

4. The method of claim 1, wherein the GUI includes each of the plurality of electronic devices, and each of the plurality of electronic devices are associated with the rule or with another rule of a plurality of rules.

5. The method of claim 4, wherein a visualization is displayed on the GUI that identifies changes in an amount of data storage space at each of the plurality of electronic devices that will be available to store other data at each of the plurality of electronic devices after data associated with the plurality of rules are deleted.

6. The method of claim 2, wherein the visualization is generated to compare the results of data storage based upon changing of parameters associated with a command.

7. The method of claim 1, wherein an alert is displayed on the GUI, the alert identifying information corresponding to the first rule.

8. The method of claim 1, wherein the range is associated with at least one of a time, a date, or an amount of memory capacity of data storage at the first electronic device.

9. The method of claim 1, wherein the first threshold corresponds to a time, a capacity of data storage, or an event, a system security breach, threat to the security of data, or a change to a security policy of the system.

10. A non-transitory computer readable storage medium having embodied thereon a program executable by a processor to implement a method for controlling the storage of data, the method comprising:
displaying a first command and a second command in a graphical user interface (GUI) on a display, wherein the first command corresponds to a first rule for deleting at least a portion of a type of data that are stored at a first electronic device of a plurality of electronic devices by identifying the first electronic device, a first range, a first threshold that corresponds to the first range, and the first rule for deleting at least the identified portion of the type of data stored at the first electronic device, and the second command corresponds to a second rule that controls the migration of data stored at a second electronic device of the plurality of electronic devices by identifying the second electronic device, a second range that is different from the first range, a second threshold that is different from the first threshold, and the second rule for controlling the migration of the identified data stored at the second electronic device;
receiving user input that executes the rules corresponding to each of the first command and the second command;
deleting data from the first electronic device based on the rule corresponding to the executed first command; and
migrating data from the second electronic device based on the rule corresponding to the executed second command.

11. The non-transitory computer readable storage medium of claim 10, the program further executable to:
perform an analysis relating to the at least identified portion of the type of data stored at the first electronic device;
generate a visualization that identifies changes in data stored at the first electronic device; and
display the visualization on the display.

12. The non-transitory computer readable storage medium of claim 11, wherein the visualization identifies changes in an amount of data storage space at the first electronic device that will be available for storing other data at the first electronic device at a time after the at least identified portion of the type of data is deleted from the first electronic device as compared to before the at least identified portion of the type of data is deleted from the first electronic device.

13. The non-transitory computer readable storage medium of claim 10, wherein the GUI includes each of the plurality of electronic devices, and each of the plurality of electronic devices are associated with the rule or with another rule of a plurality of rules.

14. The non-transitory computer readable storage medium of claim 13, wherein a visualization is displayed on the GUI that identifies changes in an amount of data storage space at each of the plurality of electronic devices that will be available to store other data at each of the plurality of electronic devices after data associated with the plurality of rules are deleted.

15. The non-transitory computer readable storage medium of claim 11, wherein the visualization is used to compare the results of data storage based upon changing of parameters associated with a command.

16. The non-transitory computer readable storage medium of claim 10, wherein an alert is displayed on the GUI, the alert identifying information corresponding to the first rule.

17. The non-transitory computer readable storage medium of claim 10, wherein the range is associated with at least one of a time, a date, or an amount of memory, or an amount of capacity of data storage at the first electronic device.

18. The method of claim 10, wherein the threshold type corresponds to a time, a capacity of data storage, or an event, a system security breach, threat to the security of data, or a change to a security policy of the system.

19. An apparatus for controlling the storage of data, the apparatus comprising: a memory;
a processor; and
a display, wherein:
a first command and a second command are displayed in a graphical user interface (GUI) on the display, wherein the first command correspond to a first rule for deleting at least a portion of a type of data that are stored at a first electronic device of a plurality of one or more electronic devices by identifying the first electronic device, a first range, a first threshold that corresponds to the first range, and the first rule for deleting at least the identified portion of the type of data stored at the first electronic device,
the second command corresponds to a second rule that controls the migration of data stored at a second electronic device of the plurality of electronic devices by identifying the second electronic device, a second range that is different from the first range, a second threshold that is different from the first threshold, and the second rule for controlling the migration of the identified data stored at the second electronic device,
user input is received that executes the rules corresponding to each of the first command and the second command,
data is deleted from the first electronic device based on the rule corresponding to the executed first command, and
data from the second electronic device is migrated based on the rule corresponding to the executed second command.

20. The method of claim 19, wherein:
an analysis relating to the at least identified portion of the type of data stored at the first electronic device is performed,
a visualization that identifies changes in data stored at the first electronic device is generated, and
the visualization is displayed on the display.
